(19) United States
(12) Patent Application Publication
(10) Pub. No.: US 2025/0039896 A1
(43) Pub. Date: Jan. 30, 2025

(54) MECHANISM FOR REPETITION OF DOWNLINK CONTROL INFORMATION

(71) Applicant: Nokia Technologies Oy, Espoo (FI)

(72) Inventors: Arman AHMADZADEH, Munich (DE); Alessio MARCONE, Munich (DE); Frank FREDERIKSEN, Aalborg (DK); Bo BI, Hangzhou (CN)

(21) Appl. No.: 18/753,700

(22) Filed: Jun. 25, 2024

(30) Foreign Application Priority Data
Jul. 28, 2023 (WO) PCT/CN2023/110028

(51) Int. Cl. H04W 72/231; H04L 1/1607; H04W 72/0446

(52) U.S. Cl. CPC H04W 72/231; H04L 1/1614; H04W 72/0446

(57) ABSTRACT

The present disclosure relates to PDCCH repetition. In particular, a network device transmits system information that includes a parameter related to a PDCCH common search space set with repetition to a terminal device. The terminal device determines a configuration of the PDCCH common search space set with repetition based on the parameters. The terminal device 110 further monitors a set of repetitions of a PDCCH based on the configuration. In this way, it can improve the coverage enhancement.

### FIELDS

Various example embodiments of the present disclosure generally relate to the field of telecommunication and in particular, to methods, devices, apparatuses and computer readable storage medium for repetitions of downlink control information transmitted in physical downlink control channel (PDCCH) search space set.

### BACKGROUND

Coverage enhancement is a hot topic in communication field. For example, it may focus on an applicability of solutions developed by general new radio (NR) coverage enhancement to non-terrestrial network (NTN), and identifying potential issues and enhancements, considering the NTN characteristics including large propagation delay and satellite movement. It is worth further studying the coverage enhancement.

### SUMMARY

In a first aspect of the present disclosure, there is provided an apparatus. The apparatus comprises at least one processor; and at least one memory storing instructions that, when executed by the at least one processor, cause the apparatus to: receive, from a network device, system information that comprises a parameter related to a physical downlink control channel (PDCCH) common search space set with repetition; determine a configuration of the PDCCH common search space set with repetition based on the parameter; and monitor, based on the configuration, a set of repetitions of the PDCCH.

In a second aspect of the present disclosure, there is provided an apparatus. The apparatus comprises at least one processor; and at least one memory storing instructions that, when executed by the at least one processor, cause the apparatus to: transmit, to a terminal device, system information that comprises a parameter related to a physical downlink control channel (PDCCH) common search space set with repetition; and transmit, to the terminal device, a set of repetitions of the PDCCH based on a configuration of the PDCCH common search space set with repetition.

In a third aspect of the present disclosure, there is provided a method. The method comprises: receiving, from a network device, system information that comprises a parameter related to a physical downlink control channel (PDCCH) common search space set with repetition; determining a configuration of the PDCCH common search space set with repetition based on the parameter; and monitoring, based on the configuration, a set of repetitions of the PDCCH.

In a fourth aspect of the present disclosure, there is provided a method. The method comprises: transmitting, to a terminal device, system information that comprises a parameter related to a physical downlink control channel (PDCCH) common search space set with repetition; and transmitting, to the terminal device, a set of repetitions of the PDCCH based on a configuration of the PDCCH common search space set with repetition.

In a fifth aspect of the present disclosure, there is provided a first apparatus. The first apparatus comprises means for receiving, from a network device, system information that comprises a parameter related to a physical downlink control channel (PDCCH) common search space set with repetition; means for determining a configuration of the PDCCH common search space set with repetition based on the parameter; and means for monitoring, based on the configuration, a set of repetitions of a PDCCH.

In a sixth aspect of the present disclosure, there is provided a second apparatus. The second apparatus comprises means for transmitting, to a terminal device, system information that comprises a parameter related to a physical downlink control channel (PDCCH) common search space set with repetition; and means for transmitting, to the terminal device, a set of repetitions of the PDCCH based on a configuration of the PDCCH common search space set with repetition.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2A to FIG. 2D illustrate schematic diagrams of monitoring occasions (MOs), respectively;

FIG. 3 illustrates a signaling chart for physical downlink control channel (PDCCH) repetitions according to example embodiments of the present disclosure;

FIG. 4A to FIG. 4C illustrate signaling chart for PDCCH repetitions according to example embodiments of the present disclosure, respectively;

FIG. 5A to FIG. 5C illustrate schematic diagrams of MOs for PDCCH repetitions according to example embodiments of the present disclosure;

FIG. 6 illustrates a flowchart of a method implemented at a first device according to some example embodiments of the present disclosure;

FIG. 7 illustrates a flowchart of a method implemented at a second device according to some example embodiments of the present disclosure;

FIG. 8 illustrates a simplified block diagram of a device that is suitable for implementing example embodiments of the present disclosure; and

FIG. 9 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), an Access Terminal (AT), or a very small aperture terminal (VSAT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “common search space (CSS)” may refer to a search space (i.e., a set of resources) that every UE needs to search for control signals for every UE or signaling message that is applied to every UE before dedicated channel is established for a specific UE. The term “a repetition factor” used herein may refer the number of repetitions. The term “bitmap” used herein may refer to a string including binary number. The term “monitoring occasion (MO)” used herein may refer to a set of resources that is used for control channel monitoring.

As mentioned above, coverage enhancement is one of the important aspects of communication system design. In NTN, when considering satellite power limitations (due to for example regulatory requirements or power split among the beams of the satellite), the UL and DL channels related to initial access need to be enhanced. In some solutions, when considering Power Flux Density (PFD) limits or more generically limits on satellite output power, coverage enhancements for the PDCCH channel are necessary.

In general, for improving coverage, there are three fundamental approaches that can be considered. These are: (a) lowering the interference and noise contributions (not relevant for this use case), (b) increasing the transmission power (not possible for this use case due to the satellite PFD limits), and (c) increasing the received energy per bit (through either reducing the payload or by transmitting over longer time). The latter is typically achieved by introducing repetitions of the channel to be enhanced. In the current 5G NR specifications, the repetition of Type0A/1/2/3 common search space (CSS) and UE specific search space (USS) PDCCH has been specified for the multi-transmission reception point (TRP) feature and its mechanism could be extended for NTN, at least for the PDCCH channels in radio resource control (RRC) connected mode. The repetition feature, however, does not apply to the PDCCH in initial access and, specifically, to the Type1-PDCCH CSS set configuration.

For improving physical layer performances of a physical layer control channel, the approach that is typically used is to assign a larger number of resources for transmission of a certain number of bits. One approach to achieve this is to repeat the transmitted data (that is a given data or control channel) multiple times, to give the possibility to a receiver to combine the received signals and improve the reliability of the demodulated and decoded bits. Based on this, one of the solutions that could be followed in the enhancements of the coverage of the Type1-PDCCH, would be to repeat the Type1-PDCCH multiple times in a same or different slot, and thereby allow a UE receiver to combine the received Type1-PDCCH single transmissions. However, in order to be able to combine the multiple Type1-PDCCH repetitions, it is necessary for the UE to know at least if and how many repetitions are being transmitted by the gNB, and hence the time span of the Type1-PDCCH repetitions.

According to some example embodiments of the present disclosure, there is provided a solution for PDCCH repetition. In particular, a network device transmits system information that includes a parameter related to a PDCCH common search space set with repetition to a terminal device. The terminal device determines a configuration of the PDCCH common search space set with repetition based on the parameters. The terminal device 110 further monitors a set of repetitions of a PDCCH based on the configuration. In this way, it can improve the coverage enhancement.

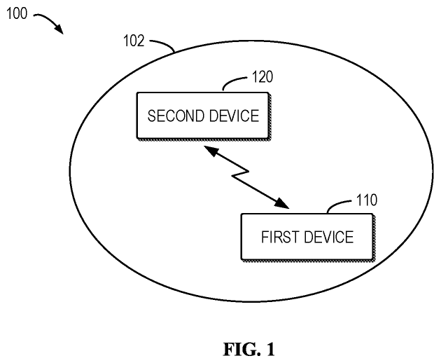

FIG. 1 illustrates an example communication environment 100 in which example embodiments of the present disclosure can be implemented. In the communication environment 100, a plurality of communication devices, including a first device 110 and a second device 120, can communicate with each other.

In the following, for the purpose of illustration, some example embodiments are described with the first device 110 operating as a terminal device and the second device 120 operating as a network device. However, in some example embodiments, operations described in connection with a terminal device may be implemented at a network device or other device, and operations described in connection with a network device may be implemented at a terminal device or other device.

The first device 110 may be capable of receiving downlink control information (DCI) carried by Type1-PDCCH CCS set with repetitions, i.e., Rel-19 NTN UEs capable of Type1-PDCCH repetition, which may also be referred to as type 1 UE. The communication environment 100 may also include other terminal devices that are not capable of receiving DCI carried by Type1-PDCCH CCS set with repetitions, including legacy UEs and Rel-19 NTN UEs not capable of Type1-PDCCH reception with repetition, which may also be referred to as type 2 UE.

In some example embodiments, if the first device 110 is a terminal device and the second device 120 is a network device, a link from the second device 120 to the first device 110 is referred to as a downlink (DL), and a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

The second device 120 may the PDCCH using resource elements (REs) that belong to a control resource set (CORESET). In particular, frequency allocation of PDCCH and the length of PDCCH (1 to 3 symbols) may be determined based on the corresponding configuration of CORESET (ControlResourceSet information element (IE)), which is shown in table 1 below. In particular, frequency allocation is configured via the parameter frequencyDomainResources and the length of PDCCH is configured via the parameter duration in ControlResourceSet IE.

TABLE 1
ControlResourceSet information element

-- ASN1 START
-- TAG-CONTROLRESOURCESET-START

| | |
|---|---|
| ControlResourceSet ::= | SEQUENCE { |

| | |
|---|---|
| controlResourceSetId | ControlResourceSetId, |
| frequencyDomainResources | BIT STRING (SIZE (45)), |
| duration | INTEGER (1..maxCoReSet Duration), |
| cce-REG-MappingType | CHOICE { |

| | |
|---|---|
| interleaved | SEQUENCE { |

| | |
|---|---|
| reg-BundleSize | ENUMERATED {n2, n3, n6}, |
| interleaverSize | ENUMERATED {n2, n3, n6}, |
| shiftIndex | INTEGER (0..maxNrofPhysicalResourceBlocks−1) |

OPTIONAL -- Need S
},

| | |
|---|---|
| nonInterleaved | NULL |

},

| | |
|---|---|
| precoderGranularity | ENUMERATED {sameAsREG-bundle, allContiguousRBs}, |
| tci-StatesPDCCH-ToAddList | SEQUENCE (SIZE (1..maxNrofTCI-StatesPDCCH)) OF TCI- |

StateId OPTIONAL, -- Cond NotSIB-initialBWP

| | |
|---|---|
| tci-StatesPDCCH-ToReleaseList | SEQUENCE (SIZE (1..maxNrofTCI-StatesPDCCH)) OF TCI- |

StateId OPTIONAL, -- Cond NotSIB-initialBWP

| | |
|---|---|
| tci-PresentInDCI | ENUMERATED {enabled} |

OPTIONAL, -- Need S

| | |
|---|---|
| pdcch-DMRS-ScramblingID | INTEGER (0..65535) |

```
OPTIONAL, -- Need S
  ...,
  [[
```

| | |
|---|---|
| rb-Offset-r16 | INTEGER (0..5) |

OPTIONAL, -- Need S

| | |
|---|---|
| tci-PresentDCI-1-2-r16 | INTEGER (1..3) |

OPTIONAL, -- Need S

| | |
|---|---|
| coreset PoolIndex-r16 | INTEGER (0..1) |

OPTIONAL, -- Need S

| | |
|---|---|
| controlResourceSetId-v1610 | ControlResourceSetId-v1610 |

```
OPTIONAL -- Need S
  ]],
  [[
```

| | |
|---|---|
| followUnifiedTCI-State-r17 | ENUMERATED {enabled} |

OPTIONAL -- Need R
]]
}
-- TAG-CONTROLRESOURCESET-STOP
-- ASN1STOP

While the frequency location of PDCCH and the length of PDCCH is configured by CORESET, potential instances of time where the first device 110 expects to monitor, and blindly perform multiple decoding attempts per monitoring occasion (MOS), of the PDCCH may be determined by the search space (SS) set. Generally, SS sets can be categorized as common search space (CSS) set, that is common for a group of UEs, and UE specific search space (USS) set, which is UE specific. Type1-PDCCH may be transmitted in a CSS set that is used by UE to blindly decode DCI formats 1_0 scheduling message 2 (MSG2) and message 4 (MSG4) in random access procedure. In 5G NR specification, SS set configuration is provided by SearchSpace IE as shown in table 2.

TABLE 2
SearchSpace information element

-- ASN1 START
-- TAG-SEARCHSPACE-START

| | |
|---|---|
| SearchSpace ::= | SEQUENCE { |

| | |
|---|---|
| searchSpaceId | SearchSpaceId, |
| controlResourceSetId | ControlResourceSetId |

OPTIONAL, -- Cond SetupOnly

| monitoringSlotPeriodicityAndOffset | CHOICE { | |
|---|---|---|
| sl1 | | NULL, |
| sl2 | | INTEGER (0..1), |
| sl4 | | INTEGER (0..3), |
| sl5 | | INTEGER (0..4), |
| sl8 | | INTEGER (0..7), |
| sl10 | | INTEGER (0..9), |
| sl16 | | INTEGER (0..15), |
| sl20 | | INTEGER (0..19), |
| sl40 | | INTEGER (0..39), |
| sl80 | | INTEGER (0..79), |
| sl160 | | INTEGER (0..159), |
| sl320 | | INTEGER (0..319), |
| sl640 | | INTEGER (0..639), |
| sl1280 | | INTEGER (0..1279), |
| sl2560 | | INTEGER (0..2559) |

}
OPTIONAL, -- Cond Setup4

| | |
|---|---|
| duration | INTEGER (2..2559) |

OPTIONAL, -- Need S

| | |
|---|---|
| monitoringSymbolsWithinSlot | BIT STRING (SIZE (14)) |

OPTIONAL, -- Cond Setup

| | |
|---|---|
| nrofCandidates | SEQUENCE { |

| | |
|---|---|
| aggregationLevel1 | ENUMERATED {n0, n1, n2, n3, n4, n5, n6, |

n8},

| | |
|---|---|
| aggregationLevel2 | ENUMERATED {n0, n1, n2, n3, n4, n5, n6, |

n8},

| | |
|---|---|
| aggregationLevel4 | ENUMERATED {n0, n1, n2, n3, n4, n5, n6, |

n8},

| | |
|---|---|
| aggregationLevel8 | ENUMERATED {n0, n1, n2, n3, n4, n5, n6, |

n8},

| | |
|---|---|
| aggregationLevel16 | ENUMERATED {n0, n1, n2, n3, n4, n5, n6, n8} |

}
OPTIONAL, -- Cond Setup

| | |
|---|---|
| searchSpaceType | CHOICE { |

| | |
|---|---|
| common | SEQUENCE { |

| | |
|---|---|
| dci-Format0-0-AndFormat1-0 | SEQUENCE { |

```
        ...
      }
OPTIONAL, -- Need R
```

| | |
|---|---|
| dci-Format2-0 | SEQUENCE { |

| | |
|---|---|
| nrofCandidates-SFI | SEQUENCE { |

| | |
|---|---|
| aggregationLevel1 | ENUMERATED {n1, n2} |

OPTIONAL, -- Need R

| | |
|---|---|
| aggregationLevel2 | ENUMERATED {n1, n2} |

OPTIONAL, -- Need R

| | |
|---|---|
| aggregationLevel4 | ENUMERATED {n1, n2} |

OPTIONAL, -- Need R

| | |
|---|---|
| aggregationLevel8 | ENUMERATED {n1, n2} |

OPTIONAL, -- Need R

| | |
|---|---|
| aggregationLevel16 | ENUMERATED {n1, n2} |

```
OPTIONAL -- Need R
        },
        ...
      }
OPTIONAL, -- Need R
```

| | |
|---|---|
| dci-Format2-1 | SEQUENCE { |

```
        ...
      }
OPTIONAL, -- Need R
```

| | |
|---|---|
| dci-Format2-2 | SEQUENCE { |

```
        ...
      }
OPTIONAL, -- Need R
```

| | |
|---|---|
| dci-Format2-3 | SEQUENCE { |

| | |
|---|---|
| dummy1 | ENUMERATED {sl1, sl2, sl4, sl5,}, |

sl8, sl10, sl16, sl20} OPTIONAL, -- Cond Setup

| | |
|---|---|
| dummy2 | ENUMERATED {n1, n2}, |

```
        ...
      }
OPTIONAL -- Need R
    },
```

| | |
|---|---|
| ue-Specific | SEQUENCE { |

| | |
|---|---|
| dci-Formats | ENUMERATED {formats0-0-And-1-0, |

```
formats0-1-And-1-1},
      ...,
      [[
```

| | |
|---|---|
| dci-Formats-MT-r16 | ENUMERATED {formats2-5} |

OPTIONAL, -- Need R

| | |
|---|---|
| dci-FormatsSL-r16 | ENUMERATED {formats0-0-And-1-0, formats0- |

1-And-1-1, formats3-0, formats3-1,

formats3-0-And-3-1}

OPTIONAL, -- Need R

| | |
|---|---|
| dci-FormatsExt-r16 | ENUMERATED {formats0-2-And-1-2, formats0- |

```
1-And-1-1And-0-2-And-1-2}
OPTIONAL -- Need R
      ]]
    }
  }
OPTIONAL -- Cond Setup2
}
```

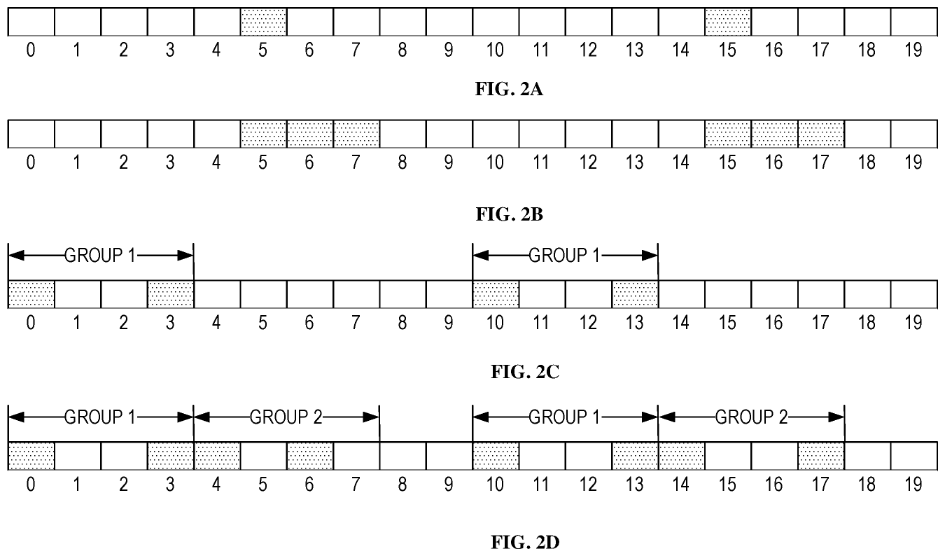

Every SS set may be associated with a certain ControlResourceSetID. Additionally, a parameter “monitoringSlotPeriodicityAndOffset” in SearchSpace IE may determine the periodicity (with a certain starting slot offset) of the slots, where the first device 110 expects to monitor PDCCH within SS set, i.e. where the PDCCH might be sent by the second device 120. For example, as shown in FIG. 2A, assuming that subcarrier spacing (SCS) is equal to 30 kHz (20 slots per frame), and the parameter “monitoringSlotPeriodicityAndOffset” in SearchSpace IE is set to Sl10 (periodicity of 10 slots) with slot offset set to 5, then the first device 110 may expect to monitor PDCCH in MOs with slot number 5 and 15.

Furthermore, the parameter “duration” in SearchSpace IE may provide information regarding the consecutive number of slots where a search space (SS) exists/lasts in every occasion as given by the periodicity and offset. In particular, if the field of the parameter “duration” in SearchSpace IE is absent, the first device 110 may apply the value 1 slot, except for DCI format 2_0. The first device 110 may ignore this field for DCI format 2_0. The maximum valid duration may be periodicity-1 (periodicity as given in the parameter “monitoringSlotPeriodicityAndOffset”). For SCS 480 kHz and SCS 960 kHz, parameter duration-r17 is used, and the configured duration may be restricted to be an integer multiple of L slots and smaller than periodicity, where L is the configured length of the bitmap monitoring SlotsWithinSlotGroup-r17. If duration-r17 is absent, the first device 110 may assume the duration in slots is equal to L. The maximum valid duration is periodicity-L.

In another example embodiment, as shown in FIG. 2B, assuming that subcarrier spacing (SCS) is equal to 30 kHz (20 slots per frame), the parameter “monitoringSlotPeriodicityAndOffset” is set to Sl10 with offset 5 the parameter “duration” is set to 3, the first device 110 may expect that every occasion exists/lasts 3 slots, and the corresponding MOs may be slots 5, 6, 7, 15, 16, and 17.

Moreover, the parameter “monitoringSymbolsWithinSlot” in SearchSpace IE configured by the second device 120, which is a bit string of size 14 may determine PDCCH location (on an OFDM symbol level) within MO slot. For example, the parameter “monitoringSymbolsWithinSlot” may define first symbol(s) for PDCCH monitoring in the slots configured for (multi-slot) PDCCH monitoring (see monitoringSlotPeriodicityAndOffset and duration). The most significant (left) bit may represent the first OFDM in a slot, and the second most significant (left) bit may represent the second OFDM symbol in a slot and so on. The bit(s) set to one identify the first OFDM symbol(s) of the control resource set within a slot.

Additionally, multi-slot PDCCH monitoring framework for FR2-2 with large SCS 480 kHz and 960 kHz may be supported by the first device 110 and the second device 120. There, due to the reduction of slot duration and avoids frequent PDCCH monitoring on slot level (for UE power saving), the first device 110 may perform PDCCH monitoring over a group of slots. In this case, the monitoring within a group of slots can be indicated by the parameter “monitoringSlotsWithinSlotGroup” by the extension of RRC IE “SearchSpace”, i.e., “SearchSpaceExt-v1700”, as shown in table 3.

TABLE 3
SEQUENCE {

| | |
|---|---|
| SearchSpaceExt-v1700 ::= | SEQUENCE { |

monitoringSlotPeriodicityAndOffset-v1710 CHOICE {

| | |
|---|---|
| sl32 | INTEGER (0..31), |
| sl64 | INTEGER (0..63), |
| sl128 | INTEGER (0..127), |
| sl5120 | INTEGER (0..5119), |
| sl10240 | INTEGER (0..10239), |
| sl20480 | INTEGER (0..20479) |

}
OPTIONAL, -- Cond Setup5

| | |
|---|---|
| monitoringSlotsWithinSlotGroup-r17 | CHOICE { |

| | |
|---|---|
| slotGroupLength4-r17 | BIT STRING (SIZE (4)), |
| slotGroupLength8-r17 | BIT STRING (SIZE (8)) |

}
OPTIONAL, -- Need R

| | |
|---|---|
| duration-r17 | INTEGER (4..20476) |

OPTIONAL, -- Need R

| | |
|---|---|
| searchSpaceType-r17 | SEQUENCE { |

| | |
|---|---|
| common-r17 | SEQUENCE { |

| | |
|---|---|
| dci-Format4-0-r17 | SEQUENCE { |

```
        ...
      }
OPTIONAL, -- Need R
```

| | |
|---|---|
| dci-Format4-1-r17 | SEQUENCE { |

```
        ...
      }
OPTIONAL, -- Need R
```

| | |
|---|---|
| dci-Format4-2-r17 | SEQUENCE { |

```
        ...
      }
OPTIONAL, -- Need R
```

| | |
|---|---|
| dci-Format4-1-AndFormat4-2-r17 | SEQUENCE { |

```
        ...
      }
OPTIONAL, -- Need R
```

| | |
|---|---|
| dci-Format2-7-r17 | SEQUENCE { |

| | |
|---|---|
| nrofCandidates-PEI-r17 | SEQUENCE { |
| aggregationLevel4-r17 | ENUMERATED {n0, n1, n2, n3, n4} |

OPTIONAL, -- Need R

| | |
|---|---|
| aggregationLevel8-r17 | ENUMERATED {n0, n1, n2} |

OPTIONAL, -- Need R

| | |
|---|---|
| aggregationLevel16-r17 | ENUMERATED {n0, n1} |

```
OPTIONAL -- Need R
        },
        ...
      }
OPTIONAL -- Need R
    }
  }
OPTIONAL, -- Need R
```

| | |
|---|---|
| searchSpaceGroupIdList-r17 | SEQUENCE (SIZE (1.. 3)) OF INTEGER (0.. |

| | |
|---|---|
| maxNrofSearchSpaceGroups−1−r17) | OPTIONAL, -- Cond DedicatedOnly |

| | |
|---|---|
| searchSpaceLinkingId-r17 | INTEGER (0..maxNrofSearchSpacesLinks−1−r17) |

OPTIONAL -- Cond DedicatedOnly

}

The parameter “monitoringSlotsWithinSlotGroup” within SearchSpaceExt-v1700 IE configured by the second device 120 may indicate which slot(s) within a slot group are configured for multi-slot PDCCH monitoring. The first (leftmost, most significant) bit represents the first slot in the slot group, the second bit represents the second slot in the slot group, and so on. A bit set to “1” indicates that the corresponding slot is configured for multi-slot PDCCH monitoring. In particular, the first device 110 identifies the MOs when “monitoringSlotsWithinSlotGroup” is provided as follows.

For example, the first device 110 may determine a PDCCH monitoring occasion on an active DL bandwidth part (BWP) from the PDCCH monitoring periodicity, the PDCCH monitoring offset, and the PDCCH monitoring pattern within a slot. If monitoringSlotsWithinSlotGroup is not provided, the first device 110 may determine that PDCCH monitoring occasions exist in a slot with number n_{s,f}^{μ} [referring to technical specification (TS) 38.211] in a frame with number n_{f} if (n_{f} Nₛₗₒₜ^{frame,μ}+n_{s,f}^{μ}−oₛ) modkₛ=0. The first device 110 may monitor PDCCH candidates for search space set s for Tₛ consecutive slots, starting from slot n_{s,f}^{μ}, and does not monitor PDCCH candidates for search space set s for the next kₛ−Tₛ consecutive slots. If monitoringSlotsWithinSlotGroup is provided, for search space set s, the first device 110 may determine that the slot with number n_{s,f}^{μ} [4, TS 38.211] in a frame with number n_{f} satisfying (n_{f} Nₛₗₒₜ^{frame,μ}+n_{s,f}^{μ}−sₛ) modkₛ=0 is the first slot in a first group of Ls slots and that PDCCH monitoring occasions exist in Tₛ/Lₛ consecutive groups of slots starting from the first group, where Lₛ is the size of monitoringSlotsWithinSlotGroup. The first device 110 may monitor PDCCH candidates for search space set s within each of the Tₛ/Lₛ consecutive groups of slots according to monitoringSlotsWithinSlotGroup, starting from slot n_{s,f}^{μ}, and does not monitor PDCCH candidates for search space set s for the next kₛ−Tₛ consecutive slots.

In an example embodiment, assuming that subcarrier spacing (SCS) is equal to 30 kHz (20 slots per frame), the parameter “monitoringSlotPeriodicityAndOffset” is set to sl10 (periodicity is set to “10”) and offset is set to “0” and that “duration” is Tₛ=4, and further assuming that the parameter “monitoringSlotsWithinSlotGroup” has a length of L_{S}=4 with bitmap, then there is one group of slots (Tₛ/Lₛ=1) for multi-slot MOs. Consequently, as shown in FIG. 2C, the first device 110 may be expected to have MOs within slots 0, 3, 10, and 13 for slots between 0 and 19.

In another example embodiment, assuming that subcarrier spacing (SCS) is equal to 30 kHz (20 slots per frame), the parameter “monitoringSlotPeriodicityAndOffset” is set to sl10 (periodicity is set to “10”) and offset is set to “0” and that “duration” is Tₛ=8, and further assuming that the parameter “monitoringSlotsWithinSlotGroup” has a length of L_{S}=4 with bitmap, then there is two groups of slots (Tₛ/Lₛ=2) for multi-slot MOs. Consequently, as shown in FIG. 2D, the first device 110 may be expected to have MOs slots 0, 3, 4, 7, 10, 13, 14 and 17 for slots between 0 and 19.

Further, the number of MOs within a group of slots provided by the parameter “monitoringSlotsWithinSlotGroup” for Type1-PDCCH CSS set may be different when Type1-PDCCH CSS set is provided by “ra-SearchSpace” in dedicated RRC signaling (i.e., after RRC connection) compare with Type1-PDCCH CSS set provided by “ra-SearchSpace” in SIB1. In particular, for Type1-PDCCH CSS set provided by ra-SearchSpace in SIB1, the PDCCH monitoring pattern may indicate only up to 1 slot in the group of slots for PDCCH monitoring. In other words, only one bit within the bitmap can be set to “1”.

Example embodiments of the present disclosure will be described in detail below with reference to the accompanying drawings.

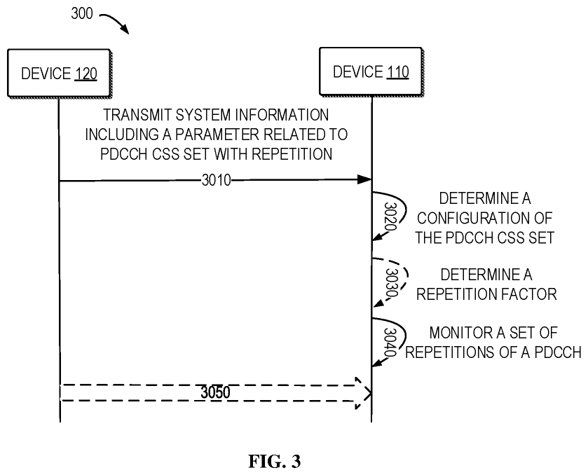

Reference is now made to FIG. 3, which shows a signaling chart 300 for communication according to some example embodiments of the present disclosure. As shown in FIG. 3, the signaling chart 300 involves a first device 110, and a second device 120. For the purpose of discussion, reference is made to FIG. 1 to describe the signaling chart 300.

The second device 120 transmits (3010) system information to the first device 110. In other words, the first device 110 receives the system information from the second device 120. The system information includes a parameter related to a PDCCH common search space set with repetition. In some example embodiments, the parameter may be in a bitmap form. In some other example embodiments, the parameter may be in a form of starting slot and slot length.

In an example embodiment, the parameter may be an existing parameter, for example, the parameter “monitoringSlotsWithinSlotGroup” and/or the parameter “duration.” In other words, the existing parameter may be reused. By way of example, a functionality of the parameter “monitoringSlotsWithinSlotGroup” may be extended such that for that for type 1 UE, the parameter “monitoringSlotsWithinSlotGroup” may specify not only the monitoring occasion for multi-slot PDCCH but also the configuration for repetition monitoring occasions of Type1-PDCCH common search space set. The expansion of the monitoring occasions through the repetition monitoring occasions may be transparent to “legacy” UEs (i.e., type 2 UE) as these would simply monitor the regular monitoring occasions, and the repeated monitoring occasions may simply be seen as carrying data (potentially for other UEs).

Alternatively, the parameter may be a new parameter. In other words, the parameter may be a dedicated parameter for the configuration of PDCCH common search space set with repetition.

The first device 110 determines (3020) a configuration of the PDCCH common search space set with repetition. For example, the first device 110 may determine (3030) a repetition factor of the PDCCH based on the parameter. By way of example, if the parameter is in the bitmap form, the repetition factor may be determined based on a length of the bitmap of the parameter. Alternatively, or in addition, the first device 110 may determine the repetition factor and a set of monitoring occasions for the set of repetitions of the PDCCH parameter.

The first device 110 monitors (3040) a set of repetitions of the PDCCH. Downlink control information (DCI) that is the payload of the PDCCH may also be repeated. PDCCH repetitions may imply DCI repetitions (i.e., payload repetitions), even if the channel bits may not be completely repeated. The DCI with cyclic redundancy check (CRC) may be scrambled by random access radio network temporary identifier (RA-RNTI) or temporary cell (TC)-RNTI scheduling message 2 (MSG2) and message 4 (MSG4) in a random access procedure. The PDCCH may be Type 1-PDCCH. Detailed example embodiments of determining the configuration of the PDCCH common search space set with repetition and monitoring the repetitions are described later with reference to different types of the parameter.

In some example embodiments, as mentioned above, the parameter may be the parameter “monitoringSlotsWithinSlotGroup”, which is a bitmap of a certain size L, when it is present, for Type1 PDCCH CSS set provided in SIB1 (i.e., before RRC connection) specifies PDCCH monitoring pattern/occasion of up to 1 slot within a group of slots indicated for PDCCH monitoring by the bitmap. In other words, not only the bitmap identifies individual monitoring occasions (not repetition occasions), but also only up to 1 monitoring occasion can be indicated via the parameter “monitoringSlotsWithinSlotGroup”.

In one example embodiment, the parameter “monitoringSlotsWithinSlotGroup” may configure the repetition number for the PDCCH. In this case, the repetition number may be implicitly carried by choosing the length of a bitmap of the parameter “monitoringSlotsWithinSlotGroup”, i.e., with L. In other words, the repetition factor can be determined based on the length of the bitmap of the parameter “monitoringSlotsWithinSlotGroup.” For example, by setting L=4, the second device 120 may indicate that the repetition factor is 4. In this case, all potential bitmaps with size L=4, i.e., [0000, 0100, 0010, 1000, 0001] may indicate the repetition factor being 4. As another example, by setting L=4, the second device 120 may indicate the repetition factor being αL, where α is a positive number. In this case, all potential bitmaps with size L=4, i.e., [0000, 0100, 0010, 1000, 0001] may indicate the repetition factor being αL.

In an example embodiment, if the length of the bitmap of the parameter equals to the repetition factor, the first device 110 may monitor (3040) the set of repetitions of the PDCCH in all slots addressed by the bitmap. In other words, if the size L indicates a repetition factor L, the PDCCH repetitions can be found in all slots belonging to the slot group.

In another example embodiment, if the length of the bitmap of the parameter does not equal to the repetition factor, the first device 110 may monitor (3040) the set of repetitions of the PDCCH in slots addressed to by the bitmap that are adjacent to a target slot indicated as a predefined value by the bitmap of the parameter. For example, if the size L indicates a repetition factor al, the PDCCH repetitions can be found at the closest slots within the slot group to the slot indicated as “1” by the bitmap of the parameter “monitoringSlotsWithinSlotGroup.”

In some example embodiments, as mentioned above, the repetition factor of the PDCCH and the set of monitoring occasions for the set of repetitions may be determined based on the parameter. For example, the parameter “monitoringSlotsWithinSlotGroup” may configure Type1-PDCCH common search space set, and the configuration of the PDCCH common search space set may carry the repetition factor and concurrently indicate the PDCCH repetition monitoring occasions within the group of slots configured with the parameter “monitoringSlotsWithinSlotGroup”. In particular, this configuration may be explicitly indicated by the bitmap of the parameter.

In an example embodiment, the first device 110 may determine the repetition factor of the PDCCH based on a number of occurrences of a predefined value in a bitmap of the parameter. The set of monitoring occasions for the set of repetitions of the PDCCH may be determined based on locations of the occurrences of the predefined value in the bitmap of the parameter. For example, within the bitmap of the parameter, the number of “1” may indicate the repetitions factor and the locations of “1” may indicate the PDCCH monitoring occasions associated with repetition candidates. By way of example, if the bitmap is [1110], the repetition factor may be 3 and the PDCCH can be repeated in the first 3 slots in the slot group. Advantageously, type 1 UE may acquire the information for repetition MOs and will not have to blindly search for PDCCH repetitions lowering complexity.

In another example embodiment, the first device 110 may determine the repetition factor of the PDCCH based on a mapping rule. For example, the mapping rule may be based on the number of a predefined value in a bitmap of the parameter and a function of length of the bitmap of the parameter. By way of example, the mapping rule may be based on scaling. Alternatively, the mapping rule may be a predefined table. For example, the predefined table may be: L=4 will be mapped to kᵣₑₚ=3; L=8 will be mapped to kᵣₑₚ=6, where L represents the length of the parameter. The first device 110 may further determine the set of monitoring occasions for the set of repetitions of the PDCCH based on locations of the predefined value in the bitmap of the parameter. For example, the parameter “monitoringSlotsWithinSlotGroup” may configure Type1-PDCCH CSS set, where the configuration of the PDCCH common search space set may carry the repetition factor and concurrently indicate potential PDCCH repetitions monitoring occasions within the group of slots configured with the parameter “monitoringSlotsWithinSlotGroup”. In particular, the repetition factor kᵣₑₚ may be indicated by the mapping rule based on the length/size (i.e., L) of the bitmap of the parameter and the potential PDCCH occasions associated to repetitions may be configured by the value of individual bits within the bitmap. As another example, the repetition factor kᵣₑₚ may be determined according to the mapping rule kᵣₑₚ=└L/2┘, and potential PDCCH repetition monitoring occasions within the group of slots may be determined by the location of bits set to “1”. For instance, if the length of the bitmap is 8 (i.e., L=8), the repetition factor may be determined as kᵣₑₚ=└L/2┘=4. Furthermore, depending on the location of “1” in the bitmap, the first device 110 may monitor the set of repetitions on potential PDCCH repetition monitoring occasions. For instance, the bitmap of [01101011] specifies slot number 2, 3, 5, 7, and 8 may be the potential repetition PDCCH monitoring occasions. Advantageously, it can provide flexibility for the scheduler, as the second device 120 is not mandated to transmit the PDCCH repetitions exactly in slots set to “1”. In the example above, although kᵣₑₚ=4, the first device 110 may need to monitor 5 slots (slot number 2, 3, 5, 7, and 8) for potential 4 PDCCH repetitions.

In a further example embodiment, the first device 110 may determine the repetition factor of the PDCCH based on a predefined offset, the number of a predefined value in a bitmap of the parameter and a length of the bitmap of the parameter. In this case, the first device 110 may determine the set of monitoring occasions for the set of repetitions of the PDCCH based on locations of the predefined value in the bitmap of the parameter. For example, the repetition factor kᵣₑₚ may be determined according to the mapping rule kᵣₑₚ=L−S_{offset}, where S_{offset} represents an offset. The potential PDCCH repetition monitoring occasions within the group of slots may be determined by the location of bits set to “1”.

In some example embodiments, if the parameter is the dedicated parameter, the parameter may be in reference to one or more durations. In one example embodiment, the bitmap of the parameter may refer to the Tₛ slots in one duration (i.e. the Tₛ consecutive slots starting from slot n_{s,f}^{μ}). In another example embodiment, the bitmap of the parameter may refer to the slots in N durations (i.e. N×Tₛ slots).

In an example embodiment, each duration may include a set of consecutive slots. For example, the set of consecutive slots within each duration is enumerated from 0 to the number of consecutive slots minus 1. For example, the parameter in the bitmap form may indicate a first number of slots in the one or more durations. Alternatively, the parameter in the form of a starting slot and slot length indicates a first slot and a number of subsequent slots in the one or more durations, based on the enumeration. In one embodiment, the Tₛ slots in one duration (i.e. the Tₛ consecutive slots starting from slot n_{s,f}^{μ}) may be enumerated from 0 to Tₛ−1 and the parameter indicates a starting slot and slot length based on such enumeration. In one embodiment, the slots in N durations (i.e. N×Tₛ slots) are enumerated from 0 to Tₛ−1 and the parameter indicates a starting slot and slot length based on such enumeration.

In an example embodiment, the bitmap of the parameter may indicate a start slot for the PDCCH common search space set with repetition. In this case, the first device 110 may determine a set of remaining slots for the PDCCH common search space set with repetition. For example, the bitmap of the parameter may only indicate the starting slot (and monitoring occasion) for the Type1-PDCCH repetitions and the remaining slots containing the repetitions may be determined by the first device 110 based on a predefined rule. For example, the first device 110 may determine the remaining slots as the consecutive slots after the starting slot.

In some example embodiments, if the parameter is in the form of a staring slot and slot length, the first device 110 may determine the set of monitoring occasions for the set of repetitions of the PDCCH based on the starting slot, the slot length and a first number of slots in the one or more durations. Alternatively, the first device 110 may determine the set of monitoring occasions for the set of repetitions based on the starting slot, the slot length, a system frame number (SFN) and slot number. For example, the slots may be enumerated based on the SFN and slot number (i.e., based on n_{s,f}^{μ} and n_{f}), and the parameter may indicate a starting slot and slot length based on such enumeration. By way of example, if the second device 120 may configure slot 0 as the starting slot and the slot length being 4, it means that 4 PDCCH repetitions may be found in monitoring occasions of slots {0,1,2,3}, where slots are enumerated based on the above embodiments.

In some example embodiments, the functionality of the parameter “duration” may be extended to provide Type1-PDCCH repetition configuration, which means the parameter “duration” can be reused. In this case, the parameter “duration” may be interpreted for type1 UE for repetition configuration and for type2 UE as legacy functioning of the parameter “duration”. In an example embodiment, values of the parameter “duration” may be mapped to values of PDCCH repetitions within the duration. In another example embodiment, a new parameter called “duration-rel19” may be introduced as the parameter related to the PDCCH common search space set with repetition. In one example implementation, the parameter “duration-rel19”, may be a bitmap that indicate the repetition factor, kᵣₑₚ, and potential PDCCH repetitions monitoring occasions.

Alternatively, the first device 110 may determine the configuration of the PDCCH common search space set with repetition based on a combination of duration parameter and monitoringSlotsWithinSlotGroup parameter indicated in the system information. For example, the configuration of the PDCCH common search space set with repetition may be acquired via combination of the parameter “duration” and the parameter “monitoringSlotsWithinSlotGroup”.

In another embodiment, SIB19, which is dedicated to NTN operation is used for proper interpretation of the parameter “duration” by type1 UE. In other words, type 1 UE that reads SIB19 may consider/interpret the parameter “duration” as the parameter related to the PDCCH common search spec set with repetition and type 2 UE (i.e., legacy UE) that does not read SIB19 may interpret the parameter “duration” as is in the legacy behavior.

The second device 120 may transmit (3050) the set of repetitions of the PDCCH to the first device 110. In an example embodiment, if the parameter is a bitmap and that a length of the bitmap equals to the repetition factor, the second device 120 may transmit the set of repetitions of the PDCCH in all slots addressed to by the bitmap. Alternatively, if the length of the parameter does not equal to the repetition factor, the second device 120 may transmit the set of repetitions of the PDCCH in slots addressed to by the bitmap that are adjacent to a target slot indicated as a predefined value by the bitmap of the parameter.

In some example embodiments, the second device 120 may transmit, to the first device 110, the set of repetitions of the PDCCH based on a mapping rule, the number of a predefined value in a bitmap of the parameter and a function of length of the bitmap of the parameter. In some other example embodiments, the second device 120 may transmit, to the first device 110, the set of repetitions of PDCCH based on a predefined offset, the number of a predefined value in a bitmap of the parameter and a length of the bitmap of the parameter.

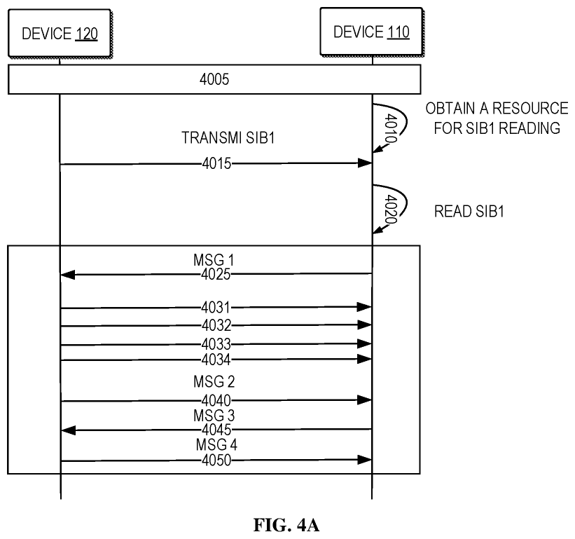

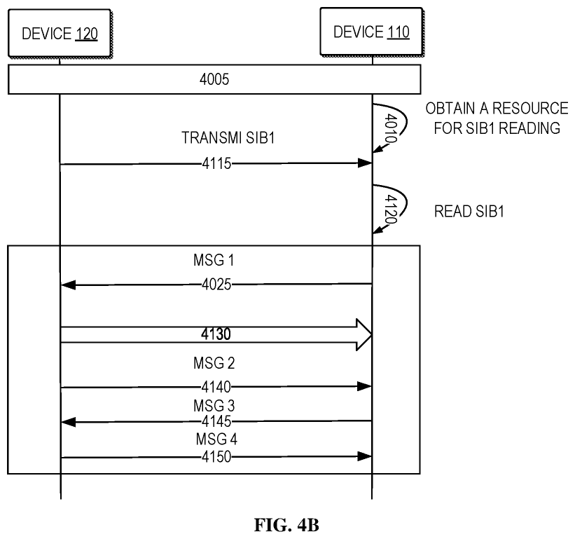

FIG. 4A to FIG. 4C illustrate signaling chart for PDCCH repetitions according to example embodiments of the present disclosure, respectively. FIG. 4A to FIG. 4C are described with reference to FIG. 5A to FIG. 5C.

As shown in FIG. 4A, the first device 110 may perform (4005) the following actions: a frequency band search, reading synchronization signal block (SSB), and acquiring master information block (MIB). The first device 110 may obtain (4010) a resource needed for reading SIB1 from MIB.

The second device 120 may transmit (4015) SIB1 with “PDCCH-ConfigCommon” IE configuring Type1-PDCCH CSS set with parameter “ra-Search Space” specifying the identity number of Type1-PDCCH and its corresponding SS set configured with “SearchSpace” IE with the following configurations. For example, SCS may be 30 kHz, and the parameter “monitoringSlotPeriodicityAndOffset” may be Sl10 with offset 5, the parameter “duration” may be set to 4, and the parameter “monitoringSlotsWithinSlotGroup” may be set to [0100].

The first device 110 may read (4020) SIB1. In this case, since the first device 110 is type 1 UE, the first device 110 may acquire repetition factor of kᵣₑₚ=4 from the size of the parameter “monitoringSlotsWithinSlotGroup” L=4, and considers all the monitoring occasions set by the parameter “monitoringSlotsWithinSlotGroup” as repetition monitoring occasions (for example, the slots 505, 506, 507, 508 and/or the slots 515, 516, 517 and 518). In another implementation, the first device 110 may acquire the repetition factor of kᵣₑₚ=4 from the size of a new parameter dedicated to indicating PDCCH repetition occasions to the first device 110 among the slots of one or multiple duration(s). The type 2 UE may consider from the parameter “monitoringSlotsWithinSlotGroup” that only one monitoring occasion slot (the slot 506 or 516) exist within the group slots for every monitoring occasion.

The first device 110 may perform a RACH procedure and may receive DCI scheduling MSG2 with 4 times repetitions (for example, on slots 505, 506, 507, 508 in FIG. 5A). For example, the first device 110 may transmit (4025) a preamble (i.e., message 1) to the second device 120. The second device 120 may perform (4031) a first transmission of the DCI scheduling MSG 2 on the slot 505 in FIG. 5A. The second device 120 may perform (4032) a second transmission of the DCI scheduling MSG 2 on the slot 506 in FIG. 5A. The second device 120 may perform (4033) a third transmission of the DCI scheduling MSG 2 on the slot 507 in FIG. 5A. The second device 120 may perform (4034) a fourth transmission of the DCI scheduling MSG 2 on the slot 508 in FIG. 5A. The second device 120 may transmit (4040) MSG 2 to the first device 110. The first devoice 110 may transmit (4045) a MSG 3 to the second device 120. The second device 120 may transmit (4050) a MSG 4 to the first device 110.

As shown in FIG. 4B, as another example, the parameter “monitoringSlotsWithinSlotGroup” or the dedicated parameter may be is a bitmap with length L=8 set to [11011011], the slot offset may be 0, and the parameter “duration” may be 8. In this case, as shown in FIG. 4B, the second device 120 may transmit (4115) SIB1 with “PDCCH-ConfigCommon” IE configuring Type1-PDCCH CSS set with parameter “ra-SearchSpace” specifying the identity number of Type1-PDCCH and its corresponding SS set configured with “SearchSpace” IE with the following configurations. For example, SCS may be 30 KHz, the parameter “monitoringSlotPeriodicityAndOffset” may be set to Sl10 with offset 0, the parameter “duration” may be set to 8, and the bitmap may be set to [11011011]. In some example embodiments, the bitmap may be configured via a new parameter in ra-SearchSpace IE.

The first device 110 may read (4120) SIB1. In this case, the first device 110 may acquire the repetition factor of kᵣₑₚ=6 from the number of “1” within the bitmap [11011011]. The first device 110 may consider all the monitoring occasion set by the bitmap setting to 1 (i.e., locations of bit “1” within the bitmap) as repetition monitoring occasions (for example, slots 500, 501, 503, 504, 506, 507 and/or slots 510, 511, 513, 514, 516, 517 in FIG. 5B).

The first device 110 may perform a RACH procedure and may receive DCI scheduling MSG2 with 6 times repetitions (for example, on slots 500, 501, 503, 504, 506, 507 in FIG. 5B). For example, the first device 110 may transmit (4025) a preamble (i.e., message 1) to the second device 120. The second device 120 may perform (4130) repetitions of the DCI scheduling MSG 2 on slots 500, 501, 503, 504, 506, 507 in FIG. 5B. The second device 120 may transmit (4140) MSG 2 to the first device 110. The first devoice 110 may transmit (4145) a MSG 3 to the second device 120. The second device 120 may transmit (4150) a MSG 4 to the first device 110.

Alternatively, the repetition factor may be determined according to some pre-determined rule, for instance as kᵣₑₚ=└L/2┘=4. In this case, the first device 110 may still consider all slots set to 1 within the bitmap as potential repetition monitoring occasions. The first device 110 may have the flexibility to transmits the four PDCCH repetitions within the 6 monitoring occasions. For example, the second device 120 may perform (4130) repetitions of the DCI scheduling MSG 2 on four slots from the slots 500, 501, 503, 504, 506, and 507.

As shown in FIG. 4C, the parameter “duration-rel19” may configure Type1-PDCCH repetitions. In this case, as shown in FIG. 4C, the second device 120 may transmit (4215) SIB1 with “PDCCH-ConfigCommon” IE configuring Type1-PDCCH CSS set with parameter “ra-SearchSpace” specifying the identity number of Type1-PDCCH and its corresponding SS set configured with “SearchSpace” IE with the following configurations. For example, SCS may be 30 kHz, and the parameter “monitoringSlotPeriodicityAndOffset” may be set to Sl10 with offset 5, the parameter “duration” may be set to 1″ and the parameter “duration-rel19” may be set to 4.

The first device 110 may read (4220) SIB1. In this case, the first device 110 may acquire the repetition factor of kᵣₑₚ=4 from the parameter “duration-rel19” and consider all the monitoring occasions set by the parameter “duration-rel19” as repetition monitoring occasions (for example, the slots 505, 506, 507, 508 and/or the slots 515, 516, 517 and 518 in FIG. 5C). The type 2 UE may acquire monitoring occasions pattern from “SearchSpace” IE and may consider only one monitoring occasion slot (the slot 506 or 516) exist within the group slots for every monitoring occasion.

The first device 110 may perform a RACH procedure and may receive DCI scheduling MSG2 with 4 times repetitions (for example, on slots 505, 506, 507, 508 and/or the slots 515, 516, 517 and 518 in FIG. 5C). For example, the first device 110 may transmit (4025) a preamble (i.e., message 1) to the second device 120. The second device 120 may perform (4230) repetitions of the DCI scheduling MSG 2 on slots 505, 506, 507, 508 in FIG. 5C. The second device 120 may transmit (4240) MSG 2 to the first device 110. The first devoice 110 may transmit (4245) a MSG 3 to the second device 120. The second device 120 may transmit (4250) a MSG 4 to the first device 110.

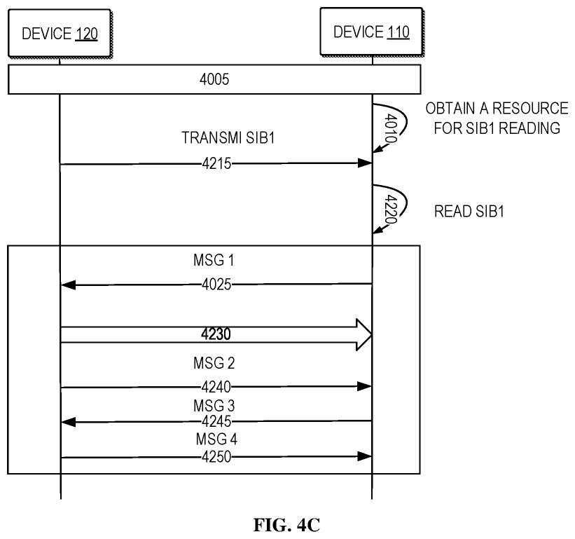

FIG. 6 shows a flowchart of an example method 600 implemented at a first device in accordance with some example embodiments of the present disclosure. For the purpose of discussion, the method 600 can be described from the perspective of the first device 110 in FIG. 1.

At block 610, the first device 110 receives, from a network device, system information that comprises a parameter related to a physical downlink control channel (PDCCH) common search space set with repetition. In some example embodiments, the parameter is in a bitmap form. In some example embodiments, the parameter is in a form of a starting slot and slot length.

At block 620, the first device 110 determines a configuration of the PDCCH common search space set with repetition based on the parameter. In some example embodiments, the method 600 further comprises: determining a repetition factor of the PDCCH based on the parameter.

At block 630, the first device 110 monitors, based on the configuration, a set of repetitions of a PDCCH. In some example embodiments, the method 600 further comprises: in accordance with a determination that the parameter is a bitmap and that a length of the bitmap equals to the repetition factor, monitoring the set of repetitions of the PDCCH in all slots addressed to by the bitmap.

In some example embodiments, the method 600 further comprises: in accordance with a determination that the parameter is a bitmap and that a length of the bitmap does not equal to the repetition factor, monitoring the set of repetitions of the PDCCH in slots addressed to by the bitmap that are adjacent to a target slot indicated as a predefined value by the bitmap of the parameter.

In some example embodiments, the method 600 further comprises: determining a repetition factor of the PDCCH and a set of monitoring occasions for the set of repetitions of the PDCCH based on the parameter.

In some example embodiments, the method 600 further comprises: determining the repetition factor of the PDCCH based on a number of occurrences of a predefined value in a bitmap of the parameter; and determining the set of monitoring occasions for the set of repetitions of the PDCCH based on locations of the occurrences of the predefined value in the bitmap of the parameter.

In some example embodiments, the method 600 further comprises: determining the repetition factor of the PDCCH based on a mapping rule, wherein the mapping rule is based on at least the number of a predefined value in a bitmap of the parameter and a function of length of the bitmap of the parameter; and determining the set of monitoring occasions for the set of repetitions of the PDCCH based on locations of the predefined value in the bitmap of the parameter.

In some example embodiments, the method 600 further comprises: determining the repetition factor of the PDCCH based on a predefined offset, the number of a predefined value in a bitmap of the parameter and a length of the bitmap of the parameter; and determining the set of monitoring occasions for the set of repetitions of the PDCCH based on locations of the predefined value in the bitmap of the parameter.

In some example embodiments, the parameter is a monitoringSlotsWithinSlotGroup parameter, or wherein the parameter is a duration parameter. In some example embodiments, the parameter is a dedicated parameter for the configuration of PDCCH common search space set with repetition.

In some example embodiments, the parameter is in reference to one or more durations, and each duration comprises a set of consecutive slots. In some example embodiments, the set of consecutive slots within each duration is enumerated from 0 to the number of consecutive slots minus 1. In some example embodiments, the parameter in the bitmap form indicates a first number of slots in the one or more durations. In some example embodiments, the parameter in the form of a starting slot and slot length indicates a first slot and a number of subsequent slots in the one or more durations, based on the enumeration.

In some example embodiments, the method 600 further comprises: determining a set of remaining slots for the PDCCH common search space set with repetition.

In some example embodiments, the method 600 further comprises: determining a set of monitoring occasions for the set of repetitions of the PDCCH based on the starting slot, the slot length and a first number of slots in the one or more durations; or determining the set of monitoring occasions for the set of repetitions based on the starting slot, the slot length, a system frame number and slot number.

In some example embodiments, the method 600 further comprises: determining the configuration of the PDCCH common search space set with repetition based on a combination of duration parameter and monitoringSlotsWithinSlotGroup parameter indicated in the system information; or in accordance with a determination that the apparatus receives another system information block, determining the configuration of the PDCCH common search space set with repetition based on a parameter duration in the system information.

In some example embodiments, the PDCCH is a Type1-PDCCH.

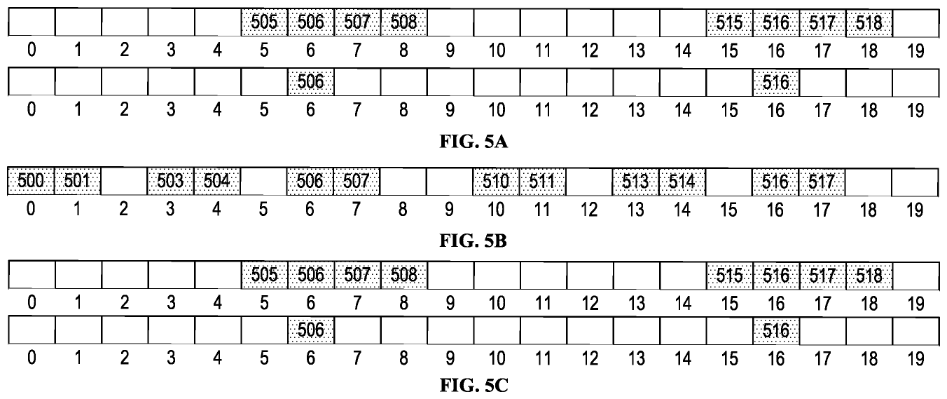

FIG. 7 shows a flowchart of an example method 700 implemented at a second device in accordance with some example embodiments of the present disclosure. For the purpose of discussion, the method 700 will be described from the perspective of the second device 120 in FIG. 1.

At block 710, the second device 120 transmits, to a terminal device, system information that comprises a parameter related to a physical downlink control channel (PDCCH) common search space set with repetition. In some example embodiments, the parameter indicates a repetition factor of the PDCCH. In some example embodiments, the PDCCH is a Type 1-PDCCH.

At block 720, the second device 120 transmits, to the terminal device, a set of repetitions of the PDCCH based on a configuration of the PDCCH common search space set with repetition. In some example embodiments, the method 700 further comprises: in accordance with a determination that the parameter is a bitmap and that a length of the bitmap equals to the repetition factor, transmitting the set of repetitions of the PDCCH in all slots addressed to by the bitmap.

In some example embodiments, the method 700 further comprises: in accordance with a determination that the parameter is a bitmap and that a length of the parameter does not equal to the repetition factor, transmitting the set of repetitions of the PDCCH in slots addressed to by the bitmap that are adjacent to a target slot indicated as a predefined value by the bitmap of the parameter.

In some example embodiments, the parameter indicates a repetition factor of the PDCCH and a set of monitoring occasions for the set of repetitions of the PDCCH.

In some example embodiments, a number of occurrences of a predefined value in a bitmap of the parameter indicates the repetition factor of the PDCCH, and locations of the occurrences of the predefined value in the bitmap of the parameter indicates the set of monitoring occasions for the set of repetitions of the PDCCH.

In some example embodiments, the method 700 further comprises: transmitting, to the terminal device, the set of repetitions of the PDCCH based on a mapping rule, the number of a predefined value in a bitmap of the parameter and a function of length of the bitmap of the parameter.

In some example embodiments, the method 700 further comprises: transmitting, to the terminal device, the set of repetitions of PDCCH based on a predefined offset, the number of a predefined value in a bitmap of the parameter and a length of the bitmap of the parameter.

In some example embodiments, the parameter is a monitoringSlotsWithinSlotGroup parameter, or wherein the parameter is a duration parameter. In some example embodiments, the parameter is a dedicated parameter for the configuration of the PDCCH common search space set with repetition.

In some example embodiments, the parameter is in a bitmap form. In some example embodiments, the parameter is in a form of a starting slot and slot length.

In some example embodiments, the parameter is in reference to one or more durations, and each duration comprises a set of consecutive slots. In some example embodiments, the set of consecutive slots within each duration is enumerated from 0 to the number of consecutive slots minus 1. In some example embodiments, the parameter in the bitmap form indicates a first number of slots in the one or more durations. In some example embodiments, the parameter in the form of a starting slot and slot length indicates a first slot and a number of subsequent slots in the one or more durations, based on the enumeration.

In some example embodiments, a bitmap of the parameter indicates a start slot for the PDCCH common search space set with repetition. In some example embodiments, the configuration of the PDCCH common search space set with repetition is indicated based on a combination of duration parameter and monitoringSlotsWithinSlotGroup parameter indicated in the system information.

In some example embodiments, a first apparatus capable of performing any of the method 600 (for example, the first device 110 in FIG. 1) may comprise means for performing the respective operations of the method 600. The means may be implemented in any suitable form. For example, the means may be implemented in a circuitry or software module. The first apparatus may be implemented as or included in the first device 110 in FIG. 1.

In some example embodiments, the first apparatus comprises means for receiving, from a network device, system information that comprises a parameter related to a physical downlink control channel (PDCCH) common search space set with repetition; means for determining a configuration of the PDCCH common search space set with repetition based on the parameter; and means for monitoring, based on the configuration, a set of repetitions of a PDCCH.

In some example embodiments, the first apparatus further comprises: means for determining a repetition factor of the PDCCH based on the parameter.

In some example embodiments, the first apparatus further comprises: means for in accordance with a determination that the parameter is a bitmap and that a length of the bitmap equals to the repetition factor, monitoring the set of repetitions of the PDCCH in all slots addressed to by the bitmap.

In some example embodiments, the first apparatus further comprises: means for in accordance with a determination that the parameter is a bitmap and that a length of the bitmap does not equal to the repetition factor, monitoring the set of repetitions of the PDCCH in slots addressed to by the bitmap that are adjacent to a target slot indicated as a predefined value by the bitmap of the parameter.

In some example embodiments, the first apparatus further comprises: means for determining a repetition factor of the PDCCH and a set of monitoring occasions for the set of repetitions of the PDCCH based on the parameter.

In some example embodiments, the first apparatus further comprises: means for determining the repetition factor of the PDCCH based on a number of occurrences of a predefined value in a bitmap of the parameter; and means for determining the set of monitoring occasions for the set of repetitions of the PDCCH based on locations of the occurrences of the predefined value in the bitmap of the parameter.

In some example embodiments, the first apparatus further comprises: means for determining the repetition factor of the PDCCH based on a mapping rule, wherein the mapping rule is based on at least the number of a predefined value in a bitmap of the parameter and a function of length of the bitmap of the parameter; and means for determining the set of monitoring occasions for the set of repetitions of the PDCCH based on locations of the predefined value in the bitmap of the parameter.

In some example embodiments, the first apparatus further comprises: means for determining the repetition factor of the PDCCH based on a predefined offset, the number of a predefined value in a bitmap of the parameter and a length of the bitmap of the parameter; and means for determining the set of monitoring occasions for the set of repetitions of the PDCCH based on locations of the predefined value in the bitmap of the parameter.

In some example embodiments, the parameter is a monitoringSlotsWithinSlotGroup parameter, or wherein the parameter is a duration parameter.

In some example embodiments, the parameter is a dedicated parameter for the configuration of PDCCH common search space set with repetition.

In some example embodiments, the parameter is in a bitmap form.

In some example embodiments, the parameter is in a form of a starting slot and slot length.

In some example embodiments, the parameter is in reference to one or more durations, and each duration comprises a set of consecutive slots.

In some example embodiments, the set of consecutive slots within each duration is enumerated from 0 to the number of consecutive slots minus 1.

In some example embodiments, the parameter in the bitmap form indicates a first number of slots in the one or more durations.

In some example embodiments, the parameter in the form of a starting slot and slot length indicates a first slot and a number of subsequent slots in the one or more durations, based on the enumeration.

In some example embodiments, a bitmap of the parameter indicates a start slot for the PDCCH common search space set with repetition, and wherein the first apparatus further comprises: means for determining a set of remaining slots for the PDCCH common search space set with repetition.

In some example embodiments, the first apparatus further comprises: means for determining a set of monitoring occasions for the set of repetitions of the PDCCH based on the starting slot, the slot length and a first number of slots in the one or more durations; or means for determining the set of monitoring occasions for the set of repetitions based on the starting slot, the slot length, a system frame number and slot number.

In some example embodiments, the first apparatus further comprises: means for determining the configuration of the PDCCH common search space set with repetition based on a combination of duration parameter and monitoringSlotsWithinSlotGroup parameter indicated in the system information; or in accordance with a determination that the apparatus receives another system information block, determining the configuration of the PDCCH common search space set with repetition based on a parameter duration in the system information.

In some example embodiments, the PDCCH is a Type1-PDCCH.

In some example embodiments, the apparatus is a terminal device.

In some example embodiments, the first apparatus further comprises means for performing other operations in some example embodiments of the method 600 or the first device 110. In some example embodiments, the means comprises at least one processor; and at least one memory storing instructions that, when executed by the at least one processor, cause the performance of the first apparatus.

In some example embodiments, a second apparatus capable of performing any of the method 700 (for example, the second device 120 in FIG. 1) may comprise means for performing the respective operations of the method 700. The means may be implemented in any suitable form. For example, the means may be implemented in a circuitry or software module. The second apparatus may be implemented as or included in the second device 120 in FIG. 1.

In some example embodiments, the second apparatus comprises means for transmitting, to a terminal device, system information that comprises a parameter related to a physical downlink control channel (PDCCH) common search space set with repetition; and means for transmitting, to the terminal device, a set of repetitions of the PDCCH based on a configuration of the PDCCH common search space set with repetition.

In some example embodiments, the parameter indicates a repetition factor of the PDCCH.

In some example embodiments, the second apparatus further comprises: means for in accordance with a determination that the parameter is a bitmap and that a length of the bitmap equals to the repetition factor, transmitting the set of repetitions of the PDCCH in all slots addressed to by the bitmap.

In some example embodiments, the second apparatus further comprises: means for in accordance with a determination that the parameter is a bitmap and that a length of the parameter does not equal to the repetition factor, transmitting the set of repetitions of the PDCCH in slots addressed to by the bitmap that are adjacent to a target slot indicated as a predefined value by the bitmap of the parameter.

In some example embodiments, the parameter indicates a repetition factor of the PDCCH and a set of monitoring occasions for the set of repetitions of the PDCCH.

In some example embodiments, a number of occurrences of a predefined value in a bitmap of the parameter indicates the repetition factor of the PDCCH, and locations of the occurrences of the predefined value in the bitmap of the parameter indicates the set of monitoring occasions for the set of repetitions of the PDCCH.

In some example embodiments, the second apparatus further comprises: means for transmitting, to the terminal device, the set of repetitions of the PDCCH based on a mapping rule, the number of a predefined value in a bitmap of the parameter and a function of length of the bitmap of the parameter.

In some example embodiments, the second apparatus further comprises: means for transmitting, to the terminal device, the set of repetitions of PDCCH based on a predefined offset, the number of a predefined value in a bitmap of the parameter and a length of the bitmap of the parameter.

In some example embodiments, the parameter is a monitoringSlotsWithinSlotGroup parameter, or wherein the parameter is a duration parameter.

In some example embodiments, the parameter is a dedicated parameter for the configuration of the PDCCH common search space set with repetition.

In some example embodiments, the parameter is in a bitmap form.

In some example embodiments, the parameter is in a form of a starting slot and slot length.

In some example embodiments, the parameter is in reference to one or more durations, and each duration comprises a set of consecutive slots.

In some example embodiments, the set of consecutive slots within each duration is enumerated from 0 to the number of consecutive slots minus 1.

In some example embodiments, the parameter in the bitmap form indicates a first number of slots in the one or more durations.

In some example embodiments, the parameter in the form of a starting slot and slot length indicates a first slot and a number of subsequent slots in the one or more durations, based on the enumeration.

In some example embodiments, a bitmap of the parameter indicates a start slot for the PDCCH common search space set with repetition.

In some example embodiments, the configuration of the PDCCH common search space set with repetition is indicated based on a combination of duration parameter and monitoringSlotsWithinSlotGroup parameter indicated in the system information.

In some example embodiments, the PDCCH is a Type 1-PDCCH.

In some example embodiments, the apparatus is a network device.

In some example embodiments, the second apparatus further comprises means for performing other operations in some example embodiments of the method 700 or the second device 120. In some example embodiments, the means comprises at least one processor; and at least one memory storing instructions that, when executed by the at least one processor, cause the performance of the second apparatus.

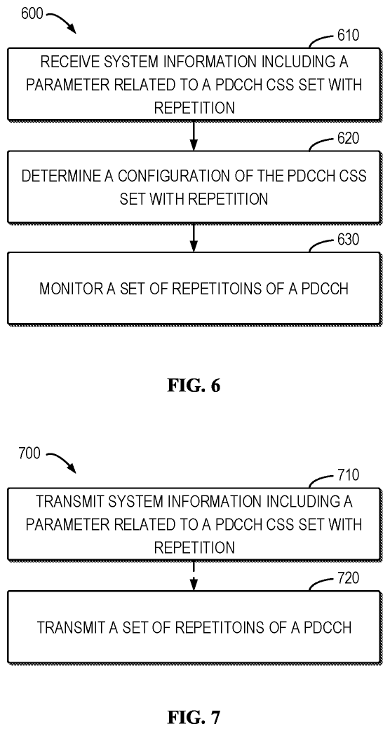

FIG. 8 is a simplified block diagram of a device 800 that is suitable for implementing example embodiments of the present disclosure. The device 800 may be provided to implement a communication device, for example, the first device 110 or the second device 120 as shown in FIG. 1. As shown, the device 800 includes one or more processors 810, one or more memories 820 coupled to the processor 810, and one or more communication modules 840 coupled to the processor 810.

The communication module 840 is for bidirectional communications. The communication module 840 has one or more communication interfaces to facilitate communication with one or more other modules or devices. The communication interfaces may represent any interface that is necessary for communication with other network elements. In some example embodiments, the communication module 840 may include at least one antenna.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The instructions of the program 830 may include instructions for performing operations/acts of some example embodiments of the present disclosure. The program 830 may be stored in the memory, e.g., the ROM 824. The processor 810 may perform any suitable actions and processing by loading the program 830 into the RAM 822.

The example embodiments of the present disclosure may be implemented by means of the program 830 so that the device 800 may perform any process of the disclosure as discussed with reference to FIG. 2 to FIG. 7. The example embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

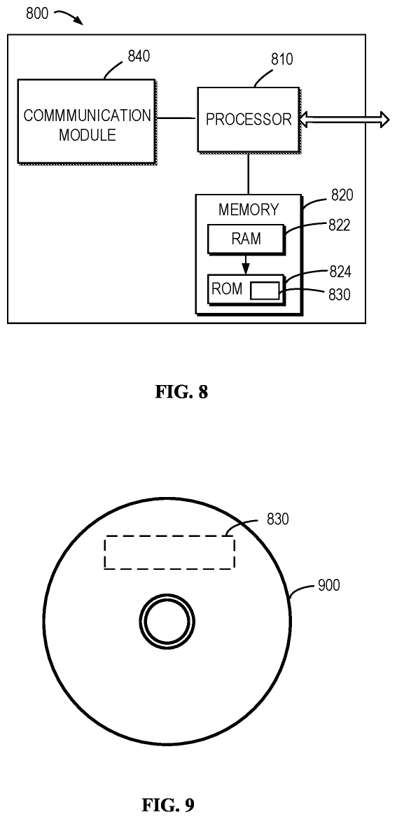

FIG. 9 shows an example of the computer readable medium 900 which may be in form of CD, DVD or other optical storage disk. The computer readable medium 900 has the program 830 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. An apparatus comprising:
at least one processor; and
at least one memory storing instructions that, when executed by the at least one processor, cause the apparatus to:
receive, from a network device, system information that comprises a parameter related to a physical downlink control channel (PDCCH) common search space set with repetition;
determine a configuration of the PDCCH common search space set with repetition based on the parameter; and
monitor, based on the configuration, a set of repetitions of a PDCCH.

2. The apparatus of claim 1, wherein the apparatus is caused to:
determine a repetition factor of the PDCCH based on the parameter.

3. The apparatus of claim 2, wherein the apparatus is caused to:
in accordance with a determination that the parameter is a bitmap and that a length of the bitmap equals to the repetition factor, monitor the set of repetitions of the PDCCH in all slots addressed to by the bitmap.

4. The apparatus of claim 2, wherein the apparatus is caused to:
in accordance with a determination that the parameter is a bitmap and that a length of the bitmap does not equal to the repetition factor, monitor the set of repetitions of the PDCCH in slots addressed to by the bitmap that are adjacent to a target slot indicated as a predefined value by the bitmap of the parameter.

5. The apparatus of claim 1, wherein the apparatus is caused to:
determine a repetition factor of the PDCCH and a set of monitoring occasions for the set of repetitions of the PDCCH based on the parameter.

6. The apparatus of claim 5, wherein the apparatus is caused to:
determine the repetition factor of the PDCCH based on a number of occurrences of a predefined value in a bitmap of the parameter; and
determine the set of monitoring occasions for the set of repetitions of the PDCCH based on locations of the occurrences of the predefined value in the bitmap of the parameter.

7. The apparatus of claim 5, wherein the apparatus is caused to:
determine the repetition factor of the PDCCH based on a mapping rule, wherein the mapping rule is based on at least the number of a predefined value in a bitmap of the parameter and a function of length of the bitmap of the parameter; and
determine the set of monitoring occasions for the set of repetitions of the PDCCH based on locations of the predefined value in the bitmap of the parameter.

8. The apparatus of claim 5, wherein the apparatus is caused to:
determine the repetition factor of the PDCCH based on a predefined offset, the number of a predefined value in a bitmap of the parameter and a length of the bitmap of the parameter; and
determine the set of monitoring occasions for the set of repetitions of the PDCCH based on locations of the predefined value in the bitmap of the parameter.

9. The apparatus of claim 1, wherein the parameter is a parameter monitoring SlotsWithinSlotGroup, or
wherein the parameter is a parameter duration.

10. The apparatus of claim 1, wherein the parameter is a dedicated parameter for the configuration of PDCCH common search space set with repetition.

11. The apparatus of claim 10, wherein the parameter is in a bitmap form.

12. The apparatus of claim 10, wherein the parameter is in a form of a starting slot and slot length.

13. The apparatus of claim 11, wherein the parameter is in reference to one or more durations, and each duration comprises a set of consecutive slots.

14. The apparatus of claim 13, wherein the set of consecutive slots within each duration is enumerated from 0 to the number of consecutive slots minus 1.

15. The apparatus of claim 13, wherein the parameter in the bitmap form indicates a first number of slots in the one or more durations.

16. The apparatus of claim 12, wherein the parameter in the form of a starting slot and slot length indicates a first slot and a number of subsequent slots in the one or more durations, based on the enumeration.

17. The apparatus of claim 12, wherein a bitmap of the parameter indicates a start slot for the PDCCH common search space set with repetition, and wherein the apparatus is caused to:
determine a set of remaining slots for the PDCCH common search space set with repetition.

18. The apparatus of claim 12, wherein the apparatus is caused to:
determine a set of monitoring occasions for the set of repetitions of the PDCCH based on the starting slot, the slot length and a first number of slots in the one or more durations; or
determine the set of monitoring occasions for the set of repetitions based on the starting slot, the slot length, a system frame number and slot number.

19. The apparatus of claim 1, wherein the apparatus is caused to:
determine the configuration of the PDCCH common search space set with repetition based on a combination of a parameter duration and a monitoringSlotsWithinSlotGroup indicated in the system information; or
in accordance with a determination that the apparatus receives another system information block, determine the configuration of the PDCCH common search space set with repetition based on a parameter duration in the system information.

20. An apparatus comprising:
at least one processor; and
at least one memory storing instructions that, when executed by the at least one processor, cause the apparatus to:
transmit, to a terminal device, system information that comprises a parameter related to a physical downlink control channel (PDCCH) common search space set with repetition; and
transmit, to the terminal device, a set of repetitions of the PDCCH based on a configuration of the PDCCH common search space set with repetition.

21. A method comprising:
receiving, at a terminal device and from a network device, system information that comprises a parameter related to a physical downlink control channel (PDCCH) common search space set with repetition;
determining, by the terminal device, a configuration of the PDCCH common search space set with repetition based on the parameter; and
monitoring, by the terminal device based on the configuration, a set of repetitions of a PDCCH.
